(19) United States
(12) Patent Application Publication
(10) Pub. No.: US 2010/0038473 A1
(43) Pub. Date: Feb. 18, 2010

(54) Aircraft Propeller Device, Method for Driving an Aircraft Propeller, Use of a Bearing for an Aircraft Propeller Drive and Use of an Electric Machine

(76) Inventors: Heinz-Dieter Schneider, Siegburg (DE); Dieter Voigt, Aachen (DE)

Correspondence Address: COLLARD & ROE, P.C., 1077 NORTHERN BOULEVARD, ROSLYN, NY, 11576, US

(21) Appl. No.: 12/448,900

(22) PCT Filed: Jan. 14, 2008
(86) PCT No.: PCT/DE2008/000036

§ 371 Date: Sep. 14, 2009

(30) Foreign Application Priority Data
Jan. 15, 2007 (DE) 10 2007 002 889.1
Nov. 19, 2007 (DE) 10 2007 055 336.8

(51) Int. Cl. B64D 35/00; F16F 15/131; F16D 9/00; F16H 57/04

(52) U.S. Cl. 244/60; 74/572.21; 464/32; 184/6.12

(57) ABSTRACT

To improve the damping of vibrations in aircraft propeller drives, the invention discloses an aircraft propeller drive comprising a propeller, a motor and a drive train between the propeller and the motor. The drive train of the aircraft propeller drive has a torsional vibration damper.

The invention relates to an aircraft propeller drive comprising a propeller, a motor, and a drive train between the propeller and the motor. Furthermore, the invention relates to a method for driving an aircraft propeller with a motor. Moreover, the invention relates to the use of a bearing, in particular a tapered roller bearing, of an aircraft propeller drive, as well as to the use of an electric machine of an aircraft propeller drive.

In the field of aircraft construction there is an increase in the use of diesel motors to drive propellers. In particular in diesel-motor-operated propellers, particularly strong vibrations on the propeller drive are encountered. It is also problematic to retrofit diesel motors to existing aircraft propeller drives which as an overload clutch comprise, for example a slip clutch between the motor and the propeller, because vibrations of the diesel motor disadvantageously are transmitted right up to the propeller, or as an alternative let the slip clutch slip accordingly.

It is the object of the present invention to prevent this.

The object of the invention is met by an aircraft propeller drive comprising a propeller, a motor, and a drive train between the propeller and the motor, in which arrangement the drive train comprises a torsional vibration damper.

In the present invention such a torsional vibration damper is particularly well suited to damping disadvantageous vibrations that emanate, in particular, from a diesel motor and that due to their intensity have a negative effect right up to the propeller.

In the present document the term “drive train” refers to any components of the aircraft propeller drive that are necessary to ensure drive force transmission between the motor and the propeller. Said term also refers to the motor shaft by means of which drive forces emanating from the motor are transmitted, as well as to the propeller shaft on which the actual propeller is held.

In the present context the term “aircraft” refers to any aircraft that comprises an airscrew, for example, in particular, corresponding fixed-wing aircraft, blended wing body aircraft, or other air craft comprising a propeller drive, including helicopters. In a manner that differs from that of means of locomotion on land, aircraft require a relatively even rotary speed of their drive, in particular once the desired flight attitude has been reached. Even in the remaining operating phases the rotary speed is relatively even, even though it then differs from the rotary speed applied in constant operation, for example at the desired flight altitude. Accordingly, the term “propeller” also refers to any other types of airscrews, in particular also to helicopter rotors with their corresponding blades.

A particularly preferred embodiment variant provides for the torsional vibration damper to comprise a dual-mass flywheel. With a dual-mass flywheel a simple design of a torsional vibration damper is implemented, which is also very safe in operation, and, in a surprising manner, is able to decouple vibrations between the propeller with its extremely high moment of inertia and a drive motor, in particular a high-torque diesel motor, even if said drive motor runs with comparatively high unevenness of rotation.

It is advantageous if the torsional vibration damper comprises mass distribution in which a primary mass of the torsional vibration damper is more than 35%, preferably more than 40% or more than 45%, while a secondary mass of the torsional vibration damper is less than 65%, preferably less than 60% or less than 55%, of the mass of the torsional vibration damper. In such mass distribution, in which vibrating mass comprises a lower percentage of the vibration damper, undesirable vibrations can be kept in check particularly effectively. Preferably, the primary mass comprises more than 55%, in particular more than 60% or more than 65% of the mass of the torsional vibration damper, while the secondary mass preferably comprises less than 45%, in particular less than 40% or less than 35% of the mass of the torsional vibration damper.

If the torsional vibration damper comprises a primary mass with a moment of inertia of between 0.035 kg/m² and 0.220 kg/m², particularly quiet running of the aircraft propeller drive is achieved. This applies in particular if the moment of inertia of the primary mass is between 0.040 kg/m² or 0.050 kg/m² on the one hand, and 0.200 kg/m² or 0.180 kg/m² on the other hand.

Furthermore, it is advantageous if the torsional vibration damper comprises means for providing additional damping mass, which means are unsuitable for the transmission of drive forces. In this arrangement the torsional vibration damper, in particular the dual-mass flywheel, advantageously comprises additional damping mass by means of which, for example, moments of torsion are not transmitted.

Accordingly, it is advantageous if with the use of the means for the additional damping mass, additional moments of inertia for vibration damping can be provided.

As a result of its additional damping mass the present torsional vibration damper differs considerably from coupling connections which, in the case of aircraft propeller drives, are conventionally used for vibration reduction, because it appears to be absurd to introduce additional movable mass to an aircraft propeller drive, which mass does not contribute to the stability of a component of the aircraft propeller drive, which component transmits drive forces.

It is advantageous if the means for the additional damping mass comprise components and/or component assemblies with a weight of more than 100 g or more than 150 g or more than 200 g. Already with such a light weight, additional damping mass can be effectively provided, and vibrations can be advantageously damped, in particular if such mass is radially arranged on the exterior of the vibration damper.

In the present context the term “additional damping mass” refers to any subassemblies or material agglomerations that are of no importance to the structural integrity of the torsional vibration damper at the specified limit loads, or that are not involved in the transmission of torque, nor are they of importance to the transmission of torque or for holding the subassemblies in a bearing arrangement.

The object of the invention is also met by an aircraft propeller drive comprising a propeller, a motor, and a drive train between the propeller and the motor, in which the drive train comprises a hydrodynamic clutch, for example a converter, in particular a Föttinger clutch.

Apart from torsional vibration dampers, such as torsionally-elastic clutches that do not permit any slippage, hydrodynamic clutches that do permit slippage can also advantageously damp vibrations in an aircraft propeller drive. For this reason, hydrodynamic clutches in a drive train of an aircraft propeller drive form outstanding torsional vibration dampers.

Due to the above-described torsional vibration dampers, for example a dual-mass flywheel, the remaining drive train can without any problems be designed so as to be essentially rigid, in other words essentially non-vibrating or damping. As a result of this rigid design, the drive train comprises a particularly simple design.

To prevent the motor of the aircraft propeller drive from becoming damaged if the propeller is abruptly stopped from externally, for example in the case of establishing contact with the ground, it is advantageous if the drive train comprises a break-off separation device.

The propeller drive can comprise a simple design if the drive train comprises a single-stage gear arrangement. Such a single-stage gear arrangement is implemented in a particularly simple manner by means of a two-shaft gear arrangement in which the two shafts are in effective contact, for example, by means of intermeshing gearwheels. The term “single-stage gear arrangements” also refers to gear arrangements comprising one or several intermediate wheels or a circumferential chain or similar, which can be used, in particular, to reverse the direction of rotation. However, it is understood that each and every intermeshing process is associated with a loss of output, and consequently the incorporation of several intermediate wheels would appear to be advantageous only in special circumstances. On the other hand, two-stage or multi-stage gear arrangements need not necessarily result in a considerable loss of output, which applies in particular to two-stage gear arrangements, in which, as a rule, the number of the intermeshing processes corresponds to the number of the intermeshing processes in a single-stage gear arrangement with an intermediate wheel, wherein a two-stage gear arrangement, depending on the transmission ratio and the remaining spatial arrangement, may comprise a radially narrower design than is the case with a corresponding single-stage gear arrangement with an intermediate wheel, even if the axial dimension is somewhat greater. Depending on the available design space, the transmission ratio required, and the torque specified, in particular for example in the case of helicopters, it is also possible to use a planetary gear arrangement.

Furthermore, the object of the invention is also met by a method for driving an aircraft propeller with a motor, in which method vibrations, in particular of the motor, are damped by means of a torsional vibration damper and/or a hydrodynamic clutch.

Torsional vibration dampers are particularly well suited to transmitting torque without any slippage, and to damping the strong vibrations of diesel motors. In contrast to this, as a rule, hydraulic clutches permit slippage during transmission of torque.

A further advantageous embodiment variant provides for the aircraft propeller drive, in particular the motor of the aircraft propeller drive, to comprise a lubricant pump for providing lubricant to regions of the aircraft propeller drive that require lubricant, for example to bearings and/or gearwheels, wherein the lubricant pump is arranged directly on a drive shaft of the motor, or on a shaft of the remaining drive train, for example on a gear-arrangement input shaft. Such an arrangement results in a particularly compact design with little loss, and is also economical to manufacture. Preferably, the lubricant pump is arranged in the drive train behind the torsional vibration damper so that the lubricant pump is not affected by any erratic running of the motor.

In the present document the term “directly” refers to an arrangement solution in which the lubricant pump is preferably seated directly on a drive shaft, gear shaft or gear input shaft, and is driven by the aforesaid in a direct way.

A further particularly advantageous embodiment variant provides for the aircraft propeller drive to comprise a lubricant pump for providing lubricant to regions of the aircraft propeller drive, which regions require lubricant, for example to bearings and/or gearwheels, wherein the lubricant pump comprises a tapered roller bearing of the aircraft propeller drive. By means of a tapered roller bearing a lubricant of the aircraft propeller drive can be conveyed, or conveyance of such a lubricant can be supported.

A version that from the design point of view is further simplified provides for the lubricant pump to be formed by means of a tapered roller bearing of the aircraft propeller drive. Depending on the design of the aircraft propeller drive, the required conveyance of a lubricant can be achieved solely on the basis of a tapered roller bearing being used.

Accordingly, according to one method variant, lubricant is conveyed to lubricant-requiring regions by means of a bearing, in particular a tapered roller bearing, of the aircraft propeller drive. If the lubricant is conveyed, in particular by means of a tapered roller bearing, the output of a motor is not reduced by a lubricant pump that otherwise would additionally have to be driven by said motor.

When in contact with a lubricant, a tapered roller bearing comprises lubricant overpressure on one side. This pressure can be utilised to convey the lubricant to the desired position. Preferably, the other side of the tapered roller bearing is connected to a corresponding lubricant sump or lubricant reservoir so that the lubricant can, without any further ado, be conveyed continuously, in particular in a loop. Since, as a rule, tapered roller bearings are lubricated anyway, and since to this effect, as a rule, the lubricant is used that also lubricates the remaining gear arrangement or the remaining drive or even the motor, such an arrangement also operates with extremely little loss, because the pressure is built-up anyway, and thus the drive has to confront this pressure anyway. To this extent this arrangement operates without any significant additional expenditure of energy, while at the same time conveying lubricant.

Since the above-described lubricant pump advantageously improves an aircraft propeller drive, the characteristics in connection with the present lubricant pump are advantageous also without the remaining characteristics of the present invention.

Independently of the remaining characteristics of the present invention, a further advantageous embodiment variant provides for the aircraft propeller drive to comprise a hybrid drive for driving the aircraft propeller drive. In this way the aircraft propeller drive can be designed so as to be comparatively light in weight.

In the present document the term “hybrid drive” refers to an aircraft propeller drive comprising more than one drive motor, which drive motors provide kinetic energy according to drive concepts that differ from each other. For example, the hybrid drive comprises an internal combustion engine by means of which chemical energy is converted to kinetic energy, and an electric motor by means of which electrical energy is converted to kinetic energy. By means of the drive motors of the hybrid drive, cumulative drive output can be provided, in particular to safeguard flight operation or for short-term ultimate output requirements.

Although in the construction of aircraft, where a lightweight design appears to be indispensable, it is absurd per se to equip an aircraft propeller drive, apart from its already existing spark ignition motor or diesel motor, in addition preferably with an electric motor, the present aircraft propeller drive preferably comprises a hybrid drive.

In order to compensate for the additional weight, advantageously an internal combustion engine, which as a rule provides the drive output for such an aircraft propeller drive, can be designed so as to be smaller, in particular less powerful, if it is possible for more output-intensive flight phases to temporarily achieve an increase in output by means of a motor that can be connected additionally.

In the context of the present document the term “electric machine” is an overall term that refers both to “electricity generators”, in other words machines that can convert mechanical energy to electrical energy, and “electric motors”, i.e. machines that can convert electrical energy to mechanical energy. In the present document these terms are not to be understood to be exclusive, and consequently, in the present context, electricity generators, if they are suitably equipped and used, can also be effective in a driving capacity; and electric motors, if they are suitably equipped and used, can also be effective in a current-generating capacity. It is precisely this bifunctionality that, as a rule, is absent in electric machines as used in conventional aircraft drives. Thus, due to its electric or electronic control, a generator/alternator, by means of which batteries can be charged, does not support its use as an electric motor. Similarly, due to its free-wheeling characteristics, a starter cannot be used for generating current. Accordingly, in the context of the present invention, the terms “electric motor” and “electricity generator” are essentially directed to the respective use of an electric machine, wherein electric machines that can be used both as generators and as motors are designated “bifunctional electric machines”.

Furthermore, the object of the invention is met in particular by the use of a bifunctional electric machine of an aircraft propeller drive as a means to increase the drive output of the aircraft propeller drive.

During the phase in which the bifunctional electric machine is used as an electric motor, the energy supply of the aircraft can be ensured by means of a high-capacity battery or an ultracapacitor.

Accordingly, independently of the remaining characteristics of the present invention, the object of the invention is also met by a method for driving an aircraft propeller with a motor, in which in a first operating state the aircraft propeller is driven by a first motor, for example an internal combustion engine, and in a second operating state, as an alternative or cumulatively, the aircraft propeller is driven by a second motor, for example an electric motor.

For example, the second motor can be switched on additionally as an output booster in a critical flight phase. As an alternative, the second motor is used in a less output-intensive flight phase, for example a gliding phase, instead of the first motor.

Control of the two motors can take place either manually by a pilot, or automatically by an electronic drive management system.

Although aircraft drives, as a rule, comprise a starter that as a rule is designed as an electric motor, according to the invention the starting procedure is not covered by any of the above-mentioned operating states, because the known starter is incorporated in the drive train by means of a free-wheeling arrangement, and is not used to drive a propeller.

To this extent it is advantageous if the two motors are coupled such that their torque or their rotary speed can be added, which in particular in the case of starters, for example due to their free-wheeling characteristics, is precisely not possible.

Accordingly, it is advantageous if in each case both motors can make possible lasting drive of the propeller. In this arrangement the term “lasting” in the present context, in delimitation to the function of a starter, in each case denotes a drive that can be operated depending on the output requirements of the propeller, even if possibly only for a very short time, for example as an output boost during takeoff procedures or in extreme situations. In contrast to this, starters are controlled depending on the rotary speed of the motor to be started.

One method variant, independently of the above-mentioned characteristics, provides for the aircraft propeller to be driven by a first motor, for example an internal combustion engine, and for the aircraft propeller during an increased demand for output to be additionally driven by a second motor, for example an electric motor.

Such an increased demand for output exists, for example, during takeoff- or ascent phases of flight, in which phases an aircraft propeller drive has to provide increased output, so that it is advantageous if at least during more output-intensive operating phases or flight phases a further motor in addition to a first motor drives a drive train.

If there is the possibility, during increased demand for output, of adding a further motor, it is possible to design the first motor so that it provides lower output so that it can also be designed to be lighter in weight, and consequently the entire aircraft propeller drive can even undergo a reduction in weight, or at least an increase in the overall weight can be avoided.

Accordingly, it is advantageous if the aircraft propeller drive comprises means to increase the drive output of the aircraft propeller drive. In this way it is possible, when required, to increase the output of the aircraft propeller drive at least for a short period of time.

If the means to increase the drive output comprise an electric motor, preferably a bifunctional electric machine, a hybrid drive in conjunction with an aircraft propeller drive can be constructed particularly easily.

Furthermore, if required, such an electric machine can be integrated in an aircraft propeller drive in a space-saving manner if said electric machine is arranged in the drive train, in particular on a drive shaft, in particular of a gear shaft of an aircraft propeller drive, which gear shaft transmits a propeller drive torque.

In this context it is particularly advantageous if an output shaft of the electric machine forms at least part of a drive shaft of the aircraft propeller drive of a gear shaft or of a gear input shaft that transmits a propeller drive torque. In this way the electric machine can be integrated without any problems in an existing drive train of an aircraft propeller drive. An electric machine that has been integrated in this way can also assume the function of a takeoff device for an internal combustion engine, so that advantageously there is no need to provide an additional starter.

Together with an already existing motor, the electric machine can simply be taken together as a compact drive unit if said electric machine is arranged between a clutch, in particular a slip clutch, and a further drive motor.

To ensure that if required the electric machine can be decoupled from the drive train of a propeller, it is advantageous if said electric machine is arranged on a gear shaft so that said electric machine can be decoupled from a propeller shaft. In this way, for example, in an incident in which the propeller is abruptly stopped the danger of damage occurring to further components of the drive train is reduced. Preferably the electric machine can be decoupled from the remaining drive train by means of a slip clutch.

A particularly advantageous component reduction within the drive train is achieved if a torsional vibration damper of the aircraft propeller drive comprises an electric machine, in particular a bifunctional electric machine. Thus, already the rotor of a unidirectional, but also of a bifunctional, electric machine can have a vibration-damping effect due to its mass. Accordingly, the rotor can, for example, form part of a primary mass or a secondary mass of a vibration damper and/or of a mass flywheel.

Furthermore, by suitably controlling the energy conversion process, active torsional vibration damping can take place already in the case of a unidirectional electric machine. This can take place, for example, in that in the case of an electricity generator electrical energy is tapped only in rotary phases in which the rotor is too fast. Furthermore, this can, for example, take place in that in the case of an electric motor electrical energy is increasingly supplied in rotary phases in which the rotor that is driven by the first motor is too slow.

However, in this respect too, a bifunctional electric machine that correspondingly can both increasingly feed in or withdraw energy appears to be particularly advantageous. Such a bifunctional electric machine can then, in particular, be used in a supplementary manner as an electricity generator or generator/alternator and/or as a starter motor.

In particular if an electric machine replaces a provided torsional vibration damper, for example the dual-mass flywheel explained above, the aircraft propeller drive features a particularly compact and thus advantageous design.

Active vibration damping of an electric machine can also, if necessary, be implemented already by means of passive electric components that enforce the desired or required phase-dependent current characteristics and voltage characteristics in the electric machine. To this effect, in particular, supplementary current storage devices and voltage storage devices such as coils and capacitors can be used. Particularly suitable in this context are ultracapacitors or supercapacitors (superCAPs), which support outstanding cycle durations and energy densities at the shortest cycle times. On the other hand, in particular also active electrical components can be used, for example transistors and similar devices, in particular control devices implemented in integrated circuits or by way of software.

Depending on concrete requirements, the following can be used as current storage devices or voltage storage devices: cumulatively in particular batteries, high-capacity batteries, storage batteries, capacitors, in particular ultracapacitors, fuel cells, electrolysis cells and similar. In this arrangement, in particular, a suitable combination of high-capacity batteries and ultracapacitors are of special importance because, for example, high-capacity batteries are designed for long-term loads and can accordingly be selected to be lighter, or at the same weight so as to provide greater capacity, while load peaks can be taken into account by way of ultracapacitors that are eminently suited to providing and absorbing load peaks. If necessary, still further, conventional, batteries can be provided, in particular for the energy supply of weak current, or for the energy supply to the remaining electrical consumers of an aircraft.

Likewise it is imaginable, by means of suitable electronic control that is adjusted to take account of the periodic erratic running of the drive motor and its rotary frequency, to use the electric machine in a torsional vibration damping manner. This applies in particular to bifunctional electric machines.

For the reasons mentioned above, a hybrid drive, and in particular the means to increase the drive output in the form of an electric machine, as well as the characteristics explained in this context, are also advantageous without the remaining characteristics of the present invention, because they already advantageously improve a conventional aircraft propeller drive.

Furthermore, the object of the invention is also met by the use of a bearing, in particular a tapered roller bearing, of an aircraft propeller drive, in particular of a motor of the aircraft propeller drive, as a lubricant pump by means of which lubricant is conveyed to regions of the aircraft that require lubricant.

With the use of a bearing as a lubricant pump the design of an aircraft propeller drive is considerably simplified, as already explained above, because it is largely possible to do without additional pumps. Furthermore, such an arrangement operates with relatively little loss.

Further advantages, objects and characteristics of the present invention are explained with reference to the following description of the enclosed drawing that diagrammatically shows aircraft propeller drives as well as individual components.

The following are shown:

FIG. 1 diagrammatically a view of an aircraft propeller drive with a drive train comprising a two-shaft gear arrangement and a dual-mass flywheel;

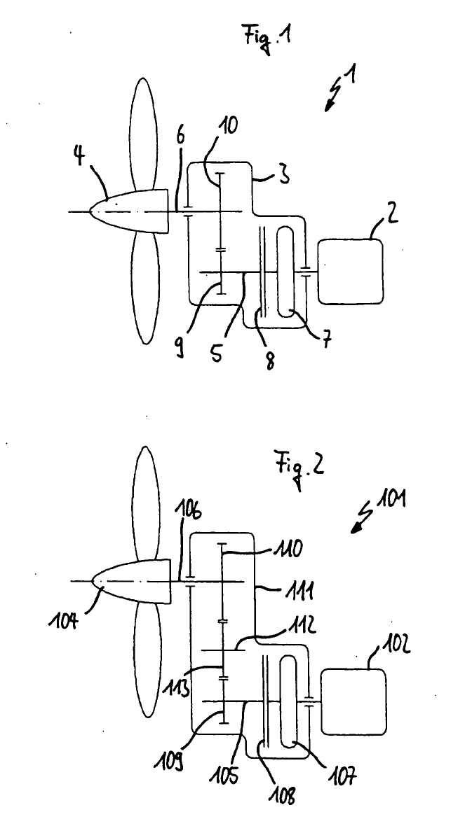

FIG. 2 diagrammatically a view of an aircraft propeller drive with a drive train comprising a three-shaft gear arrangement and a dual-mass flywheel;

FIG. 3 diagrammatically a view of an aircraft propeller drive with a drive train comprising a three-shaft gear arrangement and a dual-mass flywheel as well as a connected external gearwheel pump;

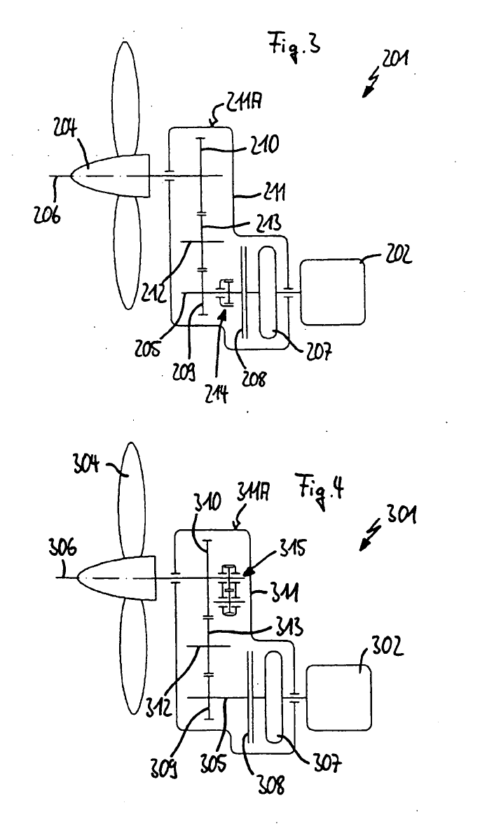

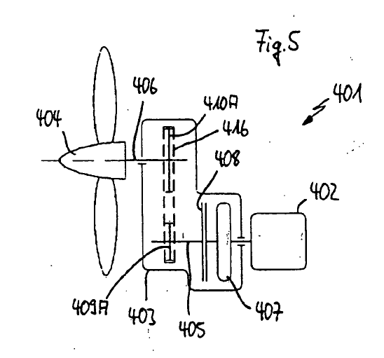

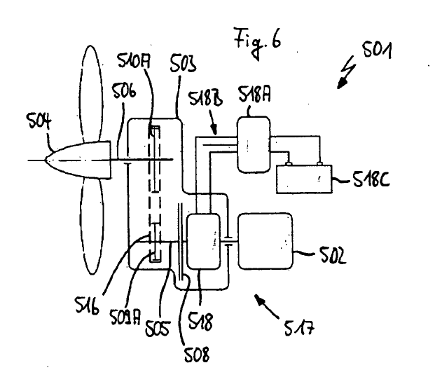

FIG. 4 diagrammatically a view of a further aircraft propeller drive with a drive train comprising a three-shaft gear arrangement and a dual-mass flywheel as well as an integrated internal gearwheel pump;

FIG. 5 diagrammatically a view of an aircraft propeller drive with a drive train with a toothed belt, wherein the drive train comprises a two-shaft gear arrangement and a dual-mass flywheel;

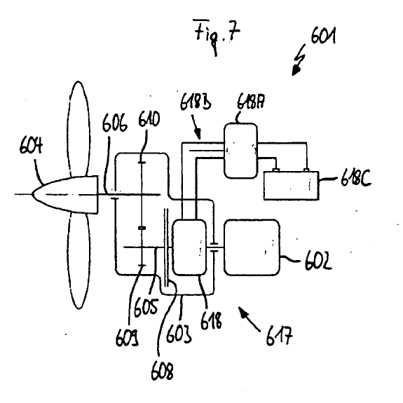

FIG. 6 diagrammatically a view of an aircraft propeller drive with a drive train with a toothed belt, wherein the drive train comprises a two-shaft gear arrangement and an electric machine as a dual-mass flywheel;

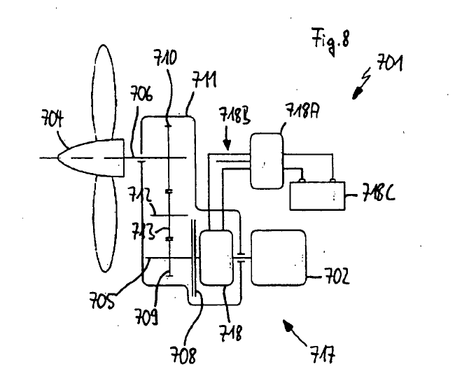

FIG. 7 diagrammatically a view of an aircraft propeller drive with a hybrid drive, with a drive train comprising a two-shaft gear arrangement and a vibration damper, wherein the vibration damper comprises an electric machine;

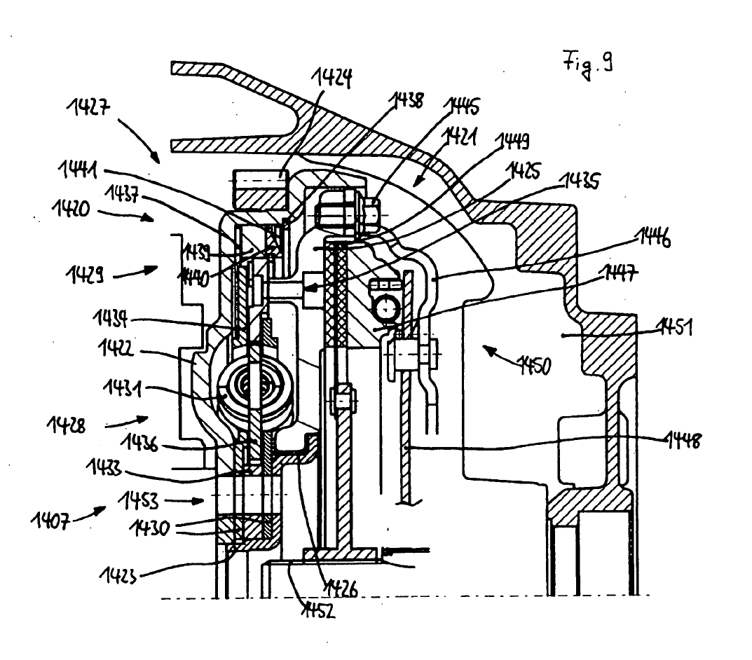

FIG. 8 diagrammatically a view of an aircraft propeller drive with a hybrid drive, with a drive train comprising a three-shaft gear arrangement and a vibration damper, wherein the vibration damper comprises an electric machine;

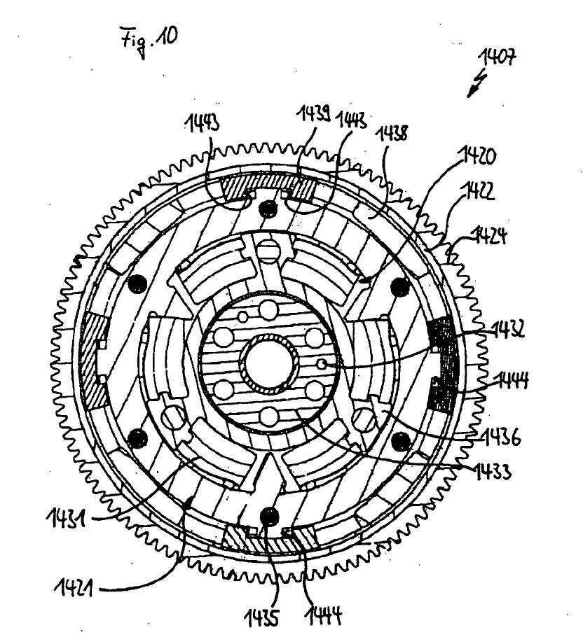

FIG. 9 diagrammatically a detailed view of a dual-mass flywheel; and

FIG. 10 diagrammatically a further view of the dual-mass flywheel of FIG. 5.

The aircraft propeller drive 1 shown in FIG. 1 comprises a diesel motor 2 that is connected to a propeller 4 by means of a two-shaft gear arrangement 3. The two-shaft gear arrangement 3 essentially comprises a gear-arrangement input shaft 5 and a propeller shaft 6 of the propeller 4. On the gear-arrangement input shaft 5, a dual-mass flywheel 7, a slip clutch 8 and an input shaft gearwheel 9 are arranged. In the present embodiment the two-shaft gear arrangement 3 is designed as a single-stage gear arrangement. The input shaft gearwheel 9 intermeshes with a propeller shaft gearwheel 10.

According to the invention, the dual-mass flywheel 7 damps vibrations that are introduced by the diesel motor 2 to the aircraft propeller drive 1 so that these vibrations are at least damped to a non-critical value and no longer have a negative effect on the slip clutch 8 or on the remaining gear arrangement.

In the present embodiment, the dual-mass flywheel 7 is designed as a torsional vibration damper with a mass ratio of primary mass to secondary mass of 60% to 40% (in this context refer also to the detailed view of a dual-mass clutch flywheel 407 of FIGS. 5 and 6).

Selecting the primary mass so that it is somewhat larger results in very quiet running characteristics of the entire aircraft propeller drive 1, so that vibrations that may emanate from the diesel motor 2 are not transmitted, or are transmitted only to a negligible extent, to the propeller 4.

In the present embodiment the slip clutch 8 that is provided forms a type of predetermined breaking point in the drive train of the aircraft propeller drive 1, which predetermined breaking point protects the aircraft propeller drive 1 from more serious destruction, for example if an abrupt disturbance of the propeller movement should occur. This can be the case if in operation the propeller 4 unintentionally contacts the ground and is prevented from rotating any further, although the diesel motor 2 continues to run and attempts to continue driving the propeller 4. It is understood that instead of this in a modified embodiment a true break-off device can also be provided, which at a particular torque separates the transmission of force or torque. It is understood that in alternative embodiments, in each case it is possible to do without the slip clutch, and in particular if applicable also without a separate predetermined breaking point, wherein if no separate predetermined breaking point is provided, if need be a specially selected subassembly, for example of the torsional vibration damper, breaks in the first instance.

For the purpose of rotatably holding individual components or subassemblies, for example the gear-arrangement input shaft 5, the aircraft propeller drive 1 comprises one or several tapered roller bearings (in the drawing not individually shown with reference characters) on whose pressure-building side oil lines are provided, which tapered roller bearings on their other side acquire an oil sump in a rolling manner, and by means of which tapered roller bearing oil is moved or conveyed within the aircraft propeller drive 1. Thus, the tapered roller bearings form an oil pump of the present aircraft propeller drive 1, thus rendering an additional oil pump superfluous.

The aircraft propeller drives explained below describe similarly designed advantageous exemplary embodiments.

The aircraft propeller drive 101 shown in FIG. 2 comprises a diesel motor 102, a three-shaft gear arrangement 111 and a propeller 104. The three-shaft gear arrangement 111 comprises a gear-arrangement input shaft 105, a propeller shaft 106 and an intermediate shaft 112.

On the gear-arrangement input shaft 105 a dual-mass flywheel 107, a slip clutch 108 and an input shaft gearwheel 109 are provided. The propeller shaft 106 comprises a propeller shaft gearwheel 110. In this exemplary embodiment the input shaft gearwheel 109 and the propeller gearwheel 110 do not directly intermesh; instead, they intermesh indirectly by way of an intermediate-shaft gearwheel 113.

The aircraft propeller drive 201 shown in FIG. 3 is essentially designed identically to the above-described aircraft propeller drive 101 from FIG. 2. It essentially comprises the following components: diesel motor 202, three-shaft gear arrangement 211, propeller 204, propeller shaft 206, dual-mass flywheel 207, slip clutch 208, input-shaft toothed-belt pulley 209, propeller shaft gearwheel 210, intermediate shaft 212 and intermediate-shaft gearwheel 213.

In addition, in the drive train between the diesel motor 202 and the propeller 204 an internal gearwheel pump 214 is arranged. Advantageously, in relation to the internal gearwheel pump 214, there is thus no further gear arrangement train required for operating the internal gearwheel pump 214 on the aircraft propeller drive 201 or on the three-shaft gear arrangement 211, and consequently the internal gearwheel pump 214 is arranged directly on a shaft of the drive train. Instead, the internal gearwheel pump 214 is driven by a shaft of the drive train between the diesel motor 202 and the propeller 204. Advantageously the internal gearwheel pump 214 can consequently also be housed in the interior of a gear arrangement housing 211A of the three-shaft gear arrangement 211 so that the entire aircraft propeller drive 201 can advantageously be designed so as to be very compact.

The internal gearwheel pump 214, which when compared to the exemplary embodiments shown above is provided in addition, is predominantly used to convey a lubricant to components, in particular of the three-shaft gear arrangement 211, which components for their proper operation require a supply of lubricant; with said internal gearwheel pump 214 thus serving as a replacement of, or supplement to, lubrication by way of tapered roller bearings.

The aircraft propeller drive 301 shown in FIG. 4 also essentially comprises the following components: diesel motor 302, three-shaft gear arrangement 311, propeller 304, gear-arrangement input shaft 305, propeller shaft 306, dual-mass flywheel 307, slip clutch 308, input shaft gearwheel 309, propeller shaft gearwheel 310, intermediate shaft 312 and intermediate-shaft gearwheel 313. In this exemplary embodiment the aircraft propeller drive 301 comprises an external gearwheel pump 315 that is driven by means of the propeller shaft 306. Since the external gearwheel pump 315 is thus driven by a shaft of the drive train between the diesel motor 302 and the propeller 304, the external gearwheel pump 315 can also be placed in a gear arrangement housing 311A of the three-shaft gear arrangement 311, which even without the characteristics of the present invention results in a simpler design of an aircraft drive. This advantage arises, in particular, also despite the fact that in this exemplary embodiment the external gearwheel pump 315 is driven only indirectly by the drive train. By means of the external gearwheel pump 315, analogously to the internal gearwheel pump of the above-described exemplary embodiment, the lubricant supply is ensured at lubrication points of the aircraft propeller drive 301.

The aircraft propeller drive 401 shown in FIG. 5 essentially represents a further exemplary embodiment of the aircraft propeller drives from FIGS. 1 and 2. The aircraft propeller drive 401 also comprises a diesel motor 402, a two-shaft gear arrangement 403 and a propeller 404. Apart from a gear-arrangement input shaft 405, the aircraft propeller drive 401 only comprises a propeller shaft 406. A slip clutch 408 and a dual-mass flywheel 407 are affixed to the gear-arrangement input shaft 405.

Neither the gear-arrangement input shaft 405 nor the propeller shaft 406 are equipped with shaft gearwheels (see for example FIG. 1, reference characters 8, 10) that directly intermesh; instead they are equipped with an input-shaft toothed-belt pulley 409A and a propeller-shaft toothed-belt pulley 410A. In this arrangement forces or torques from the input-shaft toothed-belt pulley 409A are transmitted to the propeller-shaft toothed-belt pulley 410A by means of a toothed belt 416 made of a high-strength elastic material.

Depending on the embodiment variant, in other exemplary embodiments the toothed belt 416 can be replaced with a corresponding inverted tooth type chain or ladder chain. It is clear that in an embodiment variant held in this way, the toothed belt pulleys 409A and 410A need to be replaced with suitable sprocket wheels.

Furthermore, it is understood that the aircraft propeller drive 401 can also comprise an internal gearwheel pump or, as an alternative to this, an external gearwheel pump.

The aircraft propeller drive 501 described in FIG. 6 comprises a hybrid drive 517 comprising a diesel motor 502 and an electric machine 518. The electric machine 518 can be connected either cumulatively or as an alternative to the diesel motor 502, and can thus either cause an increase in the output to the aircraft propeller drive 501, or it can exclusively produce the required drive output. In the present embodiment the electric machine 518 is designed as a bifunctional electric machine. In an alternative embodiment, this can also be a pure electric motor.

The operation of the electric machine 518 can be controlled by means of a suitable electric-machine control system 518A, which by means of suitable control lines 518B is arranged between the electric machine 518 and a battery 518C.

The battery 518C is charged by means of the electric machine 518 when the electric machine 518 is switched as an electricity generator by means of the electric-machine control device 518A. If during a particular flight phase the aircraft propeller drive 501 requires additional output that cannot be delivered by the diesel motor 502 alone, then the electric-motor control device 518A additionally connects the electric machine 518 as a motor, wherein this motor is then driven by means of energy derived from the battery 518C.

By means of the electric machine 518 added in this way, additional output is fed to the aircraft propeller drive 501.

To this effect the electric machine 518 is advantageously seated directly on a gear-arrangement input shaft 505 of the aircraft propeller drive 501 so that the output of the electric machine 518 can be introduced directly into the gear-arrangement input shaft 505. Ideally, an output shaft (in the present diagram not explicitly provided with a reference character) of the electric machine 518 forms at least part of the gear-arrangement input shaft 505.

The electric machine 518 thus forms a means to increase the nominal output of the aircraft propeller drive 501. Moreover, in this exemplary embodiment the electric machine 518 provided in this way on the gear-arrangement input shaft 505 replaces a dual-mass flywheel, as is still provided, for example, in the aircraft propeller drive 401 of FIG. 5 (see reference character 407). In this way in this exemplary embodiment advantageously a reduction in the number of components is achieved by means of the electric machine 518, because there is now no need to provide a dual-mass flywheel. It is understood that this battery 518C is preferably a high-capacity battery, and that in alternative embodiments, instead of the battery 518C, ultracapacitors or a combination of a battery and ultracapacitors, as well as in a supplementary manner a conventional battery, can advantageously be used.

Apart from the aforesaid, the aircraft propeller drive 501 comprises an identical drive. On the gear-arrangement input shaft 505 a slip clutch 508 is provided behind the electric machine 518 in order to protect the aircraft propeller drive 501 against the danger of overload. Furthermore, the aircraft propeller drive 501 comprises a two-shaft gear arrangement 503, which apart from the already explained gear-arrangement input shaft 505 also comprises a propeller shaft 506 with a propeller 504 arranged thereon.

Power transmission or torque transmission between the gear-arrangement input shaft 505 and the propeller shaft 506 is achieved by way of a toothed belt 516 that interacts with a suitable input-shaft toothed-belt pulley 509A and a propeller-shaft toothed-belt pulley 510A. The aircraft propeller drive 501 can also comprise either an internal gearwheel pump or an external gearwheel pump, as explained above.

Apart from the toothed belt variant described above in the context of the aircraft propeller drive 501, the aircraft propeller drive 601 from FIG. 7 shows a hybrid drive 617 in conjunction with a two-shaft gear arrangement 603 in which a gear-arrangement input shaft 605 and a propeller shaft 606 or its input shaft gearwheel 609 and propeller shaft gearwheel 610 intermesh directly.

In this exemplary embodiment, too, the hybrid drive 617 comprises a diesel motor 602 and an electric machine 618 arranged between said diesel motor 602 and a slip clutch 608. In particular, control of the electric machine 618 takes place by means of an electric-machine control device 618A, which is connected by way of control lines 618B not only to the electric machine 618 but also to a battery 618C. It is understood that instead of a slip clutch, even independently of the remaining characteristics of the present invention, an overload clutch with a predetermined breaking point as an overload safeguard can be used.

With this exemplary embodiment, too, the advantages, already explained above, relating to the electric machine 618 and all the associated further aircraft propeller drive components result.

Except for a three-shaft gear arrangement 711, the aircraft propeller drive 701 from FIG. 8 comprises a design that is identical to that of the aircraft propeller drive 601 from FIG. 7 so that the explanations are not repeated. Nevertheless, the essential components or subassemblies of the aircraft propeller drive 701 are briefly mentioned. The three-shaft gear arrangement 711 comprises a gear-arrangement input shaft 705 and a propeller shaft 706, between which shafts there is an intermediate shaft 712. For power transmission or torque transmission between the individual shafts 705, 706 and 712, an input shaft gearwheel 709, an intermediate-shaft gearwheel 713 and a propeller shaft gearwheel 710 interact.

On the gear-arrangement input shaft 705, between a slip clutch 708 and the diesel motor 702, the electric machine 718 is attached, wherein, in particular, the operation of the electric machine 718 is controlled by means of an electric-machine control device 718A. In order to be able to control the electric machine 718, control lines 718B are provided, by means of which the electric machine 718 is also connected to a battery 718C.

Finally, in relation to the two aircraft propeller drives 601 and 701 it should be mentioned that either of them can comprise either an internal gearwheel pump or an external gearwheel pump.

The dual-mass flywheel 1407 shown in FIGS. 9 and 10 describes in detail an exemplary embodiment of a dual-mass flywheel with an integrated slip clutch as can advantageously be used in one of the aircraft propeller drives described above.

The dual-mass flywheel 1407 comprises a primary mass 1420 and a secondary mass 1421. In this arrangement the primary mass 1421 comprises a primary plate 1422 and a centring flange 1423. Furthermore, the primary plate 1422 carries a toothed starter ring 1424. The secondary mass 1421 essentially comprises a secondary plate 1425 that is rotatably held on the centring flange 1423 by way of a sliding bearing 1426.

Apart from this rotatable bearing arrangement, the two masses 1420 and 1421 interact by way of a spring-damper arrangement 1427. This spring-damper arrangement 1427 comprises a spring component 1428 and a friction component 1429. It is understood that, if need be, the spring component 1428 does not act exclusively in a spring-like capacity, but also acts in a frictional and also damping or energy-converting capacity, while the friction component 1429 acts not only in a damping capacity, but within certain limits can also comprise spring-like characteristics.

In the dual-mass slip-clutch flywheel 1407 shown in FIGS. 9 and 10, which can, for example, be used in the above-mentioned exemplary embodiments, in each case primary-side and secondary-side subassemblies are provided which from the respective mass 1420 or 1421 create an effective connection to the spring-damper arrangement 1427 or to the spring component 1428 and to the friction component 1429.

On the primary side, in relation to the spring component 1428, this is a primary double spring disc 1430, which encompasses springs 1431 of the spring component 1428 and which is positioned in a non-rotational manner on the centring flange 1423, by way of screw connections through screw holes 1432, relative to the primary mass 1420 and relative to the primary plate 1422, the centring flange 1423 and a spacer plate 1433. Accordingly, the secondary mass 1421 comprises a spring disc 1434 on the secondary side, which spring disc 1434 is positioned in openings 1435 on the secondary plate 1425 by way of a rivet connection, and also encompasses the spring 1431. The spring component 1428 moreover encompasses a free spring plate 1436 that is used for positioning the springs 1431.

On the primary side the friction component 1429 comprises two pressure discs 1437 and 1438 as well as wedges 1439 and 1440 that are axially tensioned towards each other by way of a saucer spring 1441 which is arranged between the second wedge 1440 and the second pressure disc 1438. The wedges 1439 and 1440 comprise thicknesses that vary in circumferential direction. In this arrangement one of the wedges 1439, 1440, namely the first wedge 1439 which rests against the first pressure disc 1437, establishes a rotary connection with the secondary-side spring disc 1442 of the secondary mass 1421, wherein the first wedge 1439 in circumferential direction comprises first stops 1443, against which the secondary-side spring disc 1442 comes to a stop with further stops 1444 at certain angles of rotation.

The first pressure disc 1437 is designed as a sliding disc on which the first wedges 1439 can slide. The second wedges 1440 are connected in a non-rotational manner with the saucer spring 1441 and with the first pressure disc 1437, wherein the saucer spring 1441 in turn is connected in a non-rotational manner, by way of the second pressure disc 1438, with the primary plate 1422 which is affixed in a groove (without reference character) of the primary plate 1422. By means of this arrangement, varying frictional forces between the two masses 1420 and 1421 can be generated by way of the rotational angle.

By means of the secondary plate 1425, the dual-mass slip-clutch flywheel 1407 is connected, by way of screws 1445, with a clutch housing 1446, which in turn carries a clutch thrust plate 1447 with a saucer spring 1448 that presses the clutch thrust plate 1447 against a friction disc 1449 that is jammed between the clutch thrust plate 1447 and the secondary plate 1425. Essentially, by means of the secondary plate 1425, the clutch thrust plate 1447 and the friction disc 1449, an integrated slip clutch 1450 is implemented.

In the frictionally-engaged state, torque is transmitted from a drive shaft 1452, by way of the primary mass 1420, the spring-damper arrangement 1427, the secondary mass 1421 and the clutch thrust plate 1447, to the friction disc 1449 and thus to a drive shaft 1452 that is connected with the friction disc 1449. The drive shaft is connected to the primary mass 1420 by way of screws that are arranged in screw openings 1453 of the subassemblies 1422, 1423, 1430 and 1433. The entire arrangement is arranged in a clutch space 1451.

List of reference characters:

| | |
|---|---|
| 1 | Aircraft propeller drive |
| 2 | Diesel motor |
| 3 | Two-shaft gear arrangement |
| 4 | Propeller |
| 5 | Gear-arrangement input shaft |
| 6 | Propeller shaft |
| 7 | Dual-mass flywheel |
| 8 | Slip clutch |
| 9 | Input shaft gearwheel |
| 10 | Propeller shaft gearwheel |
| 101 | Aircraft propeller drive |
| 102 | Diesel motor |
| 104 | Propeller |
| 105 | Gear-arrangement input shaft |
| 106 | Propeller shaft |
| 107 | Dual-mass flywheel |
| 108 | Slip clutch |
| 109 | Input shaft gearwheel |
| 110 | Propeller shaft gearwheel |
| 111 | Three-shaft gear arrangement |
| 112 | Intermediate shaft |
| 113 | Intermediate-shaft gearwheel |
| 201 | Aircraft propeller drive |
| 202 | Diesel motor |
| 204 | Propeller |
| 205 | Gear-arrangement input shaft |
| 206 | Propeller shaft |
| 207 | Dual-mass flywheel |
| 208 | Slip clutch |
| 209 | Input shaft gearwheel |
| 210 | Propeller shaft gearwheel |
| 211 | Three-shaft gear arrangement |
| 211A | Gear arrangement housing |
| 212 | Intermediate shaft |
| 213 | Intermediate-shaft gearwheel |
| 214 | Internal gearwheel pump |
| 301 | Aircraft propeller drive |
| 302 | Diesel motor |
| 304 | Propeller |
| 305 | Gear-arrangement input shaft |
| 306 | Propeller shaft |
| 307 | Dual-mass flywheel |
| 308 | Slip clutch |
| 309 | Input shaft gearwheel |
| 310 | Propeller shaft gearwheel |
| 311 | Three-shaft gear arrangement |
| 311A | Gear arrangement housing |
| 312 | Intermediate shaft |
| 313 | Intermediate-shaft gearwheel |
| 315 | External gearwheel pump |
| 401 | Aircraft propeller drive |
| 402 | Diesel motor |
| 403 | Two-shaft gear arrangement |
| 404 | Propeller |
| 405 | Gear arrangement input shaft |
| 406 | Propeller shaft |
| 407 | Dual-mass flywheel |
| 408 | Slip clutch |
| 409A | Input-shaft toothed-belt pulley |
| 410A | Propeller-shaft toothed-belt pulley |
| 416 | Toothed belt |
| 501 | Aircraft propeller drive |
| 502 | Diesel motor |
| 503 | Two-shaft gear arrangement |
| 504 | Propeller |
| 505 | Gear-arrangement input shaft |
| 506 | Propeller shaft |
| 507 | Dual-mass flywheel |
| 508 | Slip clutch |
| 509A | Input-shaft toothed-belt pulley |
| 510A | Propeller-shaft toothed-belt pulley |
| 516 | Toothed belt |
| 517 | Hybrid drive |
| 518 | Electric machine |
| 518A | Electric-machine control device |
| 518B | Control lines |
| 518C | High-capacity battery |
| 601 | Aircraft propeller drive |
| 602 | Diesel motor |
| 603 | Two-shaft gear arrangement |
| 604 | Propeller |
| 605 | Gear-arrangement input shaft |
| 606 | Propeller shaft |
| 608 | Slip clutch |
| 609A | Input-shaft toothed-belt pulley |
| 610A | Propeller-shaft toothed-belt pulley |
| 616 | Toothed belt |
| 617 | Hybrid drive |
| 618 | Electric machine |
| 618A | Electric-machine control device |
| 618B | Control lines |
| 618C | High-capacity battery |
| 701 | Aircraft propeller drive |
| 702 | Diesel motor |
| 704 | Propeller |
| 705 | Gear-arrangement input shaft |
| 706 | Propeller shaft |
| 708 | Slip clutch |
| 709A | Input-shaft toothed-belt pulley |
| 710A | Propeller-shaft toothed-belt pulley |
| 711 | Three-shaft gear arrangement |
| 712 | Intermediate shaft |
| 713 | Intermediate-shaft gearwheel |
| 716 | Toothed belt |
| 717 | Hybrid drive |
| 718 | Electric machine |
| 718A | Electric-machine control device |
| 718B | Control lines |
| 718C | High-capacity battery |
| 1407 | Dual-mass flywheel |
| 1420 | Primary mass |
| 1421 | Secondary mass |
| 1422 | Primary plate |
| 1423 | Centring flange |
| 1424 | Toothed starter ring |
| 1425 | Secondary plate |
| 1426 | Sliding bearing |
| 1427 | Spring-damper arrangement |
| 1428 | Spring component |
| 1429 | Friction component |
| 1430 | Double spring washer |
| 1431 | Springs |
| 1432 | Screw holes |
| 1433 | Spacer plate |
| 1434 | Spring disc on the secondary side |
| 1435 | Openings |
| 1436 | Free spring plate |
| 1437 | First pressure disc |
| 1438 | Second pressure disc |
| 1439 | First wedge |
| 1440 | Second wedge |
| 1441 | Saucer spring |
| 1443 | First stops |
| 1444 | Further stops |
| 1445 | Screws |
| 1446 | Clutch housing |
| 1447 | Clutch thrust plate |
| 1448 | Saucer spring |
| 1449 | Friction disc |
| 1450 | Integrated slip clutch |
| 1451 | Clutch space |
| 1452 | Drive shaft |
| 1453 | Screw opening |

1. An aircraft propeller drive comprising a propeller, a motor, and a drive train between the propeller and the motor, wherein the drive train comprises a dual-mass flywheel (7).

2. The aircraft propeller drive according to claim 1, wherein the dual-mass flywheel (7) comprises mass distribution in which a primary mass (420) of the torsional vibration damper is more than 35%, while a secondary mass (421) of the torsional vibration damper is less than 65%, of the mass of the torsional vibration damper.

3. The aircraft propeller drive according to claim 2, wherein the dual-mass flywheel (7) comprises mass distribution in which a primary mass (420) of the torsional vibration damper is up to 65%, while a secondary mass (421) of the torsional vibration damper is up to 35%, of the mass of the torsional vibration damper.

4. The aircraft propeller drive according to claim 1, wherein the dual-mass flywheel (7) comprises a primary mass (420) with a moment of inertia of between 0.035 kg/m² and 0.220 kg/m².

5. The aircraft propeller drive according to claim 1, wherein the dual-mass flywheel (7) comprises means for providing additional damping mass, which means are unsuitable for the transmission of drive forces.

6. The aircraft propeller drive according to claim 5, wherein with the use of the means for the additional damping mass, additional moments of inertia for vibration damping can be provided.

7. The aircraft propeller drive according to claim 5, wherein the means for the additional damping mass comprise components and/or component assemblies with a weight of more than 100 g.

8. An aircraft propeller drive comprising a propeller, a motor, and a drive train between the propeller and the motor, wherein the drive train comprises a hydrodynamic clutch, for example a converter, in particular a Föttinger clutch.

9. The aircraft propeller drive according to claim 1, wherein otherwise, i.e. except for a torsional vibration damper or a hydrodynamic clutch, the drive train is rigid.

10. The aircraft propeller according to claim 1, wherein the drive train comprises a break-off separation device.

11. The aircraft propeller drive according to claim 1, further comprising a lubricant pump for providing lubricant to regions of the aircraft propeller drive that require lubricant, for example to bearings and/or gearwheels, wherein the lubricant pump is arranged directly on a drive shaft of the motor, or on a shaft of the drive train or on a gear-arrangement input shaft.

12. The aircraft propeller drive according to claim 1, further comprising a lubricant pump for providing lubricant to regions of the aircraft propeller drive, which regions require lubricant, for example to bearings and/or gearwheels, wherein the lubricant pump comprises a tapered roller bearing of the aircraft propeller drive.

13. The aircraft propeller drive according to claim 1, further comprising a lubricant pump for providing lubricant to regions of the aircraft propeller drive, which regions require lubricant, for example to bearings and/or gearwheels, wherein the lubricant pump is formed by means of a tapered roller bearing of the aircraft propeller drive.

14. The aircraft propeller drive according to claim 1, further comprising a hybrid drive (517) for driving the aircraft propeller (501).

15. The aircraft propeller drive according to claim 1, further comprising means to increase the drive output of the aircraft propeller drive (501).

16. The aircraft propeller drive according to claim 15, wherein the means to increase the drive output comprise an electric motor (518).

17. The aircraft propeller drive according to claim 1, wherein an electric motor (518) is arranged on a gear shaft of the aircraft propeller drive (501).

18. The aircraft propeller drive according to claim 1, wherein an output shaft of an electric motor (518) forms at least part of a gear shaft of the aircraft propeller drive (501).

19. The aircraft propeller drive according to claim 1, wherein an electric motor (518) is arranged between a clutch, in particular a slip clutch (508), and a further drive motor (502).

20. The aircraft propeller drive according to claim 1, wherein an electric motor (518) is arranged on a gear shaft so that it can be decoupled from a propeller shaft (506).

21. The aircraft propeller drive according to claim 16, wherein the electric motor is a bifunctional electric machine.

22. The aircraft propeller drive according to claim 1, wherein a torsional vibration damper of the aircraft propeller drive (501) comprises a bifunctional electric machine (518).

23. The aircraft propeller drive according to claim 14, further comprising a storage device for electrical energy in the form of a high-capacity battery of an ultracapacitor.

24. The aircraft propeller drive according to claim 1, further comprising two motors whose torque and/or rotary speed can be added when required.

25. A method for driving an aircraft propeller with a motor, wherein vibrations, in particular of the motor, are damped by means of a dual-mass flywheel (7).

26. The method according to claim 25, wherein by means of a bearing, in particular a tapered roller bearing of the aircraft propeller drive, lubricant can be conveyed to regions that require lubricant.

27. The method according to claim 25, wherein in a first operating state the aircraft propeller drive (501) is driven by a first motor, for example an internal combustion engine (502), and in a second operating state, as an alternative or cumulatively, the aircraft propeller drive (501) is driven by a second motor, for example an electric motor (518).

28. The method according to claim 25, wherein the aircraft propeller drive (501) is driven by a first motor, for example an internal combustion engine (502) and, if there is an increased demand for output, the aircraft propeller drive (501) is additionally driven by a second motor, for example an electric motor (518).

29. The method according to claim 27, wherein both the first motor and the second motor can be operated for a long time.

30. The method according to claim 25, wherein at least during output-intensive operating phases or flight phases, for example during takeoff or ascent, a further motor (518) in addition to a first motor (502) drives a shared gear shaft.

31. The method according to claim 25, wherein by means of an electric machine, by means of which electrical energy is provided, additional drive output is introduced into the aircraft propeller drive (501).

32. The method according to claim 27, wherein electrical energy is held in intermediate storage in an ultracapacitor.

33. The use of a bearing, in particular a tapered roller bearing, of an aircraft propeller drive, in particular of a motor of the aircraft propeller drive, as a lubricant pump by means of which lubricant is conveyed to regions of the aircraft that require lubricant.

34. The use of an electric machine of an aircraft propeller drive as a means to increase the drive output of the aircraft propeller drive.
